(19) United States
(12) Patent Application Publication
(10) Pub. No.: US 2018/0081112 A1
(43) Pub. Date: Mar. 22, 2018

(54) ACOUSTIC RIDGE OR RIB WAVEGUIDES IN LOW-LOSS INTEGRATED OPTICAL PLATFORMS

(71) Applicant: Honeywell International Inc., Morris Plains, NJ (US)

(72) Inventors: Matthew Wade Puckett, Scottsdale, AZ (US); Tiequn Qiu, Glendale, AZ (US); Mary K. Salit, Plymouth, MN (US); Jianfeng Wu, Tucson, AZ (US)

(21) Appl. No.: 15/591,747

(22) Filed: May 10, 2017

Related U.S. Application Data
(60) Provisional application No. 62/397,064, filed on Sep. 20, 2016.

(51) Int. Cl. G02B 6/122; G02B 6/136; G10K 11/24; G01C 19/66

(52) U.S. Cl. CPC G02B 6/122; G02B 6/136; G02B 2006/12138; G01C 19/661; G10K 11/24

(57) ABSTRACT

A waveguide device comprises a substrate having an upper surface and a first width; a cladding layer over the upper surface of the substrate, the cladding layer comprising a first material having a first refractive index, wherein the cladding layer has a second width that is less than the first width; and an optical core surrounded by the cladding layer, the optical core comprising a second material having a second refractive index that is higher that the first refractive index such that an optical signal will propagate through the optical core. The cladding layer that surrounds the optical core has a thickness configured to substantially confine acoustic waves to the cladding layer when the optical signal propagates through the optical core.

### CROSS REFERENCE TO RELATED APPLICATION

This application claims the benefit of priority to U.S. Provisional Application No. 62/397,064, filed on Sep. 20, 2016, which is herein incorporated by reference.

### STATEMENT REGARDING FEDERALLY SPONSORED RESEARCH OR DEVELOPMENT

This invention was made with Government support under N66001-16-C-4017 awarded by SPAWAR Systems Center Pacific. The Government has certain rights in the invention. This material is based upon work supported by the Defense Advanced Research Projects Agency (DARPA) and Space and Naval Warfare Systems Center Pacific (SSC Pacific).

### BACKGROUND

Brillouin scattering, an interaction between light and sound which results in the exchange of energy among optical wavelengths, can be leveraged to create high-sensitivity integrated ring laser gyroscopes. Brillouin scattering benefits both from low-loss guiding of light and guiding of acoustic waves, but typically, it is difficult to attain both of these properties simultaneously in integrated waveguides.

In the past, high Brillouin gain coefficients have been realized in integrated devices by suspending unclad waveguides in air, thereby removing the path by which acoustic waves can radiate away. However, this technique comes at the cost of increasing optical propagation loss, due to the increased overlap of the optical mode with high-index-contrast material interfaces. Furthermore, unclad waveguides such as these are very susceptible to physical damage, making them less viable for practical or commercial applications.

Alternatively, ultra-low loss waveguides have been produced by reducing optical confinement in thin films of silicon nitride surrounded by silicon dioxide. In these devices, the low propagation loss cannot be attained without expanding the mode area, and no acoustic guiding is present. The Brillouin gain coefficient of these devices is thus expected to be low.

### SUMMARY

A waveguide device comprises a substrate having an upper surface and a first width; a cladding layer over the upper surface of the substrate, the cladding layer comprising a first material having a first refractive index, wherein the cladding layer has a second width that is less than the first width; and an optical core surrounded by the cladding layer, the optical core comprising a second material having a second refractive index that is higher that the first refractive index such that an optical signal will propagate through the optical core. The cladding layer that surrounds the optical core has a thickness configured to substantially confine acoustic waves to the cladding layer when the optical signal propagates through the optical core.

### BRIEF DESCRIPTION OF THE DRAWINGS

Features of the present invention will become apparent to those skilled in the art from the following description with reference to the drawings. Understanding that the drawings depict only typical embodiments and are not therefore to be considered limiting in scope, the invention will be described with additional specificity and detail through the use of the accompanying drawings, in which:

FIG. 1 is a cross-sectional end view of an acoustic rib waveguide device according to one embodiment;

FIG. 2 is a cross-sectional end view of an acoustic ridge waveguide device according to another embodiment;

FIGS. 3A-3C are end views showing an exemplary method of fabricating an acoustic rib waveguide device;

FIGS. 4A-4C are end views showing an exemplary method of fabricating an acoustic ridge waveguide device;

FIGS. 5A-5D are graphical representations of lowest-order acoustic modes for acoustic ridge waveguide devices with different sized cladding regions;

FIG. 6 is a graphical representation of the lowest-order acoustic mode for an acoustic rib waveguide device; and

FIG. 7 is a perspective view of an integrated fiber optic gyroscope that can employ an acoustic rib or ridge waveguide device, according to an exemplary embodiment.

### DETAILED DESCRIPTION

In the following detailed description, embodiments are described in sufficient detail to enable those skilled in the art to practice the invention. It is to be understood that other embodiments may be utilized without departing from the scope of the invention. The following detailed description is, therefore, not to be taken in a limiting sense.

Waveguide devices are disclosed in which acoustic waves are confined to an area around a waveguide core without significantly altering or inducing the optical propagation loss of the waveguide devices. In one embodiment, an acoustic ridge waveguide in a low-loss integrated optical platform is provided. In another embodiment, an acoustic rib waveguide in a low-loss integrated optical platform is provided.

The waveguides devices can be fabricated by removing a range of cladding material surrounding a waveguide optical core, while the remaining cladding material is protected with a mask. This results in the formation of an acoustic ridge or rib waveguide that confines acoustic waves to the area around the optical core.

For example, the cladding region surrounding the optical core can be etched away by a thickness ranging from about 1-30 microns, and a width around the waveguide ranging from about 1-30 microns can be protected from the etch with a mask composed of photoresist, electron beam resist, a metal, or the like.

The present approach provides for fabricating waveguide devices with tailorable optical loss and confinement, as well as acoustic confinement. For example, the degree of acoustic confinement may be increased by reducing the dimensions of the cladding region surrounding the optical waveguide, or vice versa. The boundaries of the acoustic waveguide may be placed closer to the optical waveguide without inducing additional scattering loss if the optical mode area is small, corresponding to a high degree of optical confinement.

This technique allows for an increased and tunable Brillouin gain coefficient without making concessions in terms of the optical propagation loss of the waveguide device. During operation of the waveguide device, an optical mode is excited at the input of the waveguide device, such as with a laser. Due to the electrostriction of the guiding material, acoustic waves will be generated that tend to radiate outward away from the waveguide device. The solid-air material interfaces above and to either side of the waveguide device will reflect the acoustic waves back toward the optical mode at the center of the cladding material, as will the material interface between the cladding and substrate material below the waveguide. This will increase the degree of interaction between the optical and acoustic waves, thereby increasing the Brillouin gain coefficient.

Further details of the present waveguide devices and methods for their fabrication are described hereafter with reference to the drawings.

FIG. 1 illustrates an acoustic rib waveguide device 100, according to one embodiment. The waveguide device 100 generally includes a substrate 110, a cladding layer 120 over an upper surface of substrate 110, and an optical core 130 embedded in and surrounded by cladding layer 120. In addition, opposing rib sections 140, 142 extend from lower portions of sidewall surfaces of cladding layer 120, over the upper surface of substrate 110.

The cladding layer 120 and rib sections 140, 142 are composed of a first material having a first refractive index (n_{cladding}). The optical core 130 is composed of a second material having a second refractive index (n_{core}) that is higher that the first refractive index, such that an optical signal will propagate through optical core 130. In addition, the thickness of cladding layer 120 around optical core 130 is configured to substantially confine acoustic waves to cladding layer 120 when an optical signal propagates through optical core 130.

The optical core 130 can be composed of various optical guiding materials. Exemplary optical guiding materials include silicon, silicon nitride (SiNx), silicon oxynitride (SiON), silicon carbide (SiC), diamond, silicon germanium (SiGe), germanium, gallium arsenide (GaAs), gallium nitride (GaN), gallium phosphide (GaP), lithium niobate (LiNbO₃), or combinations thereof.

The cladding layer 120 can be composed of various cladding materials, such as silicon dioxide (SiO₂), silicon oxynitride, zinc oxide (ZnO), aluminum oxide (Al₂O₃), calcium fluoride (CaF₂), or combinations thereof.

The substrate 110 can be composed of any wafer material (n_{substrate}) that is atomically flat, such as any of the above materials. The optical and acoustic properties of substrate 110 do not matter, because the substrate should be far enough removed from optical core 130 to not interact with the waveguide operation. However, for acoustic guiding, the cladding material needs to possess an acoustic velocity (speed of sound) which is distinct from the substrate material acoustic velocity, in order to reflect acoustic waves.

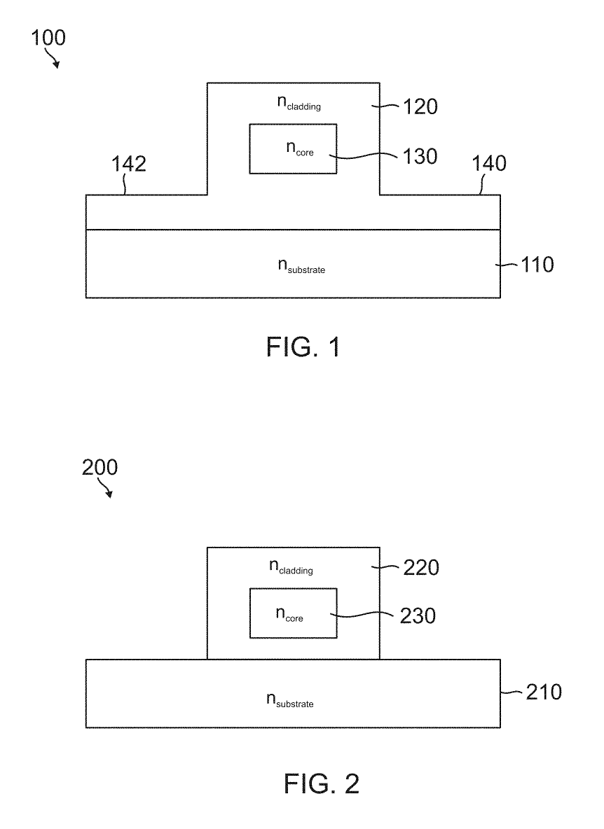

FIG. 2 illustrates an acoustic ridge waveguide device 200, according to another embodiment. The waveguide device 200 generally includes a substrate 210, a cladding layer 220 over an upper surface of substrate 210, and an optical core 230 embedded in and surrounded by cladding layer 220. The waveguide device 200 does not include any rib sections as described above for waveguide device 100. This leaves the upper surface of substrate 110 exposed on either side of the sidewall surfaces of cladding layer 120.

The cladding layer 220 is composed of a first material having a first refractive index (n_{cladding}), and optical core 230 is composed of a second material having a second refractive index (n_{core}) that is higher that the first refractive index, such that an optical signal will propagate through optical core 230. In addition, the thickness of cladding layer 220 around optical core 230 is configured to substantially confine acoustic waves to cladding layer 220 when an optical signal propagates through optical core 230. The optical core 230, cladding layer 220, and substrate 210 can be composed of the same materials as described above for waveguide device 100.

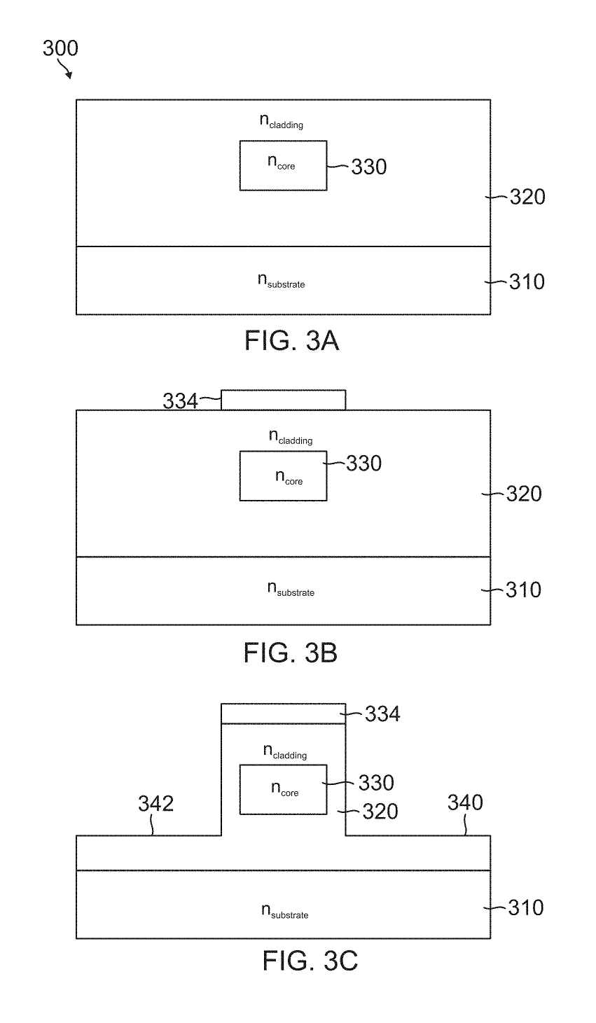

FIGS. 3A-3C depict an exemplary method of fabricating an acoustic rib waveguide device. Fabrication of the acoustic rib waveguide device begins with an integrated optical waveguide 300, as shown in FIG. 3A. The integrated optical waveguide 300 may be formed through a number of different conventional techniques. The integrated optical waveguide 300 is formed with a wafer substrate 310, a cladding layer 320 supported by wafer substrate 310, and an optical core 330 embedded in cladding layer 320. The material of optical core 330 has a refractive index larger than that of the surrounding material of cladding layer 320 and supports optical modes that are confined near to the waveguide. It is additionally necessary for acoustic guiding that the material of cladding layer 320 possesses an acoustic velocity which is distinct from wafer substrate 310, in order to reflect acoustic waves.

Following deposition of a top portion of cladding layer 320 over optical core 330 to form integrated optical waveguide 300, a range of cladding material surrounding optical core 330 is to be removed, while the remaining cladding material is protected with a mask 334, as shown in FIG. 3B. The protection may be achieved by using a mask composed of photoresist, electron beam resist, or a metal.

A wet or dry etch step can then be carried out, as depicted in FIG. 3C, during which the area of cladding layer 320 surrounding core 330 and below mask 334 is protected. The etch step is performed partially through cladding layer 320 to leave opposing rib sections 340 and 342, composed of the cladding material, over the upper surface of substrate 310, resulting in formation of the acoustic rib waveguide device. In an optional step, mask 334 may then be removed from remaining cladding layer 320 by conventional techniques.

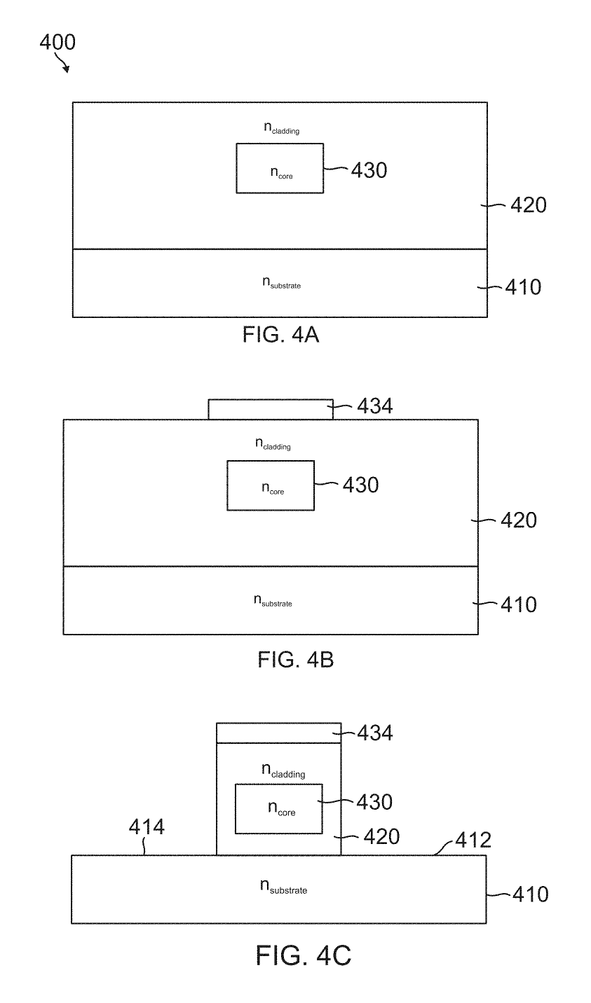

FIGS. 4A-4C depict an exemplary method of fabricating an acoustic ridge waveguide device. Fabrication of the acoustic ridge waveguide device begins with an integrated optical waveguide 400, as shown in FIG. 4A. The integrated optical waveguide 400 may be formed through a number of different conventional techniques. The integrated optical waveguide 400 is formed with a wafer substrate 410, a cladding layer 420 supported by wafer substrate 410, and an optical core 430 embedded in cladding layer 420. The material of optical core 430 has a refractive index larger than that of the surrounding material of cladding layer 420, and the cladding material has an acoustic velocity that is distinct from wafer substrate 410.

Following deposition of a top portion of cladding layer 420 over optical core 430 to form integrated optical waveguide 400, a range of cladding material surrounding optical core 430 is to be removed, while the remaining cladding material is protected with a mask 434, as shown in FIG. 4B. The protection may be achieved by using a mask composed of photoresist, electron beam resist, or a metal.

A wet or dry etch step can then be carried out, as depicted in FIG. 4C, during which the area of cladding layer 420 surrounding optical core 430 and below mask 434 is protected. The etch step is performed to remove the entire thickness of cladding layer 420 not protected by mask 434. This leaves exposed portions 412 and 414 of the upper surface of substrate 410 on either side of sidewall surfaces of cladding layer 420, resulting in formation of the acoustic ridge waveguide device. In an optional step, mask 434 may then be removed from remaining cladding layer 420 by conventional techniques.

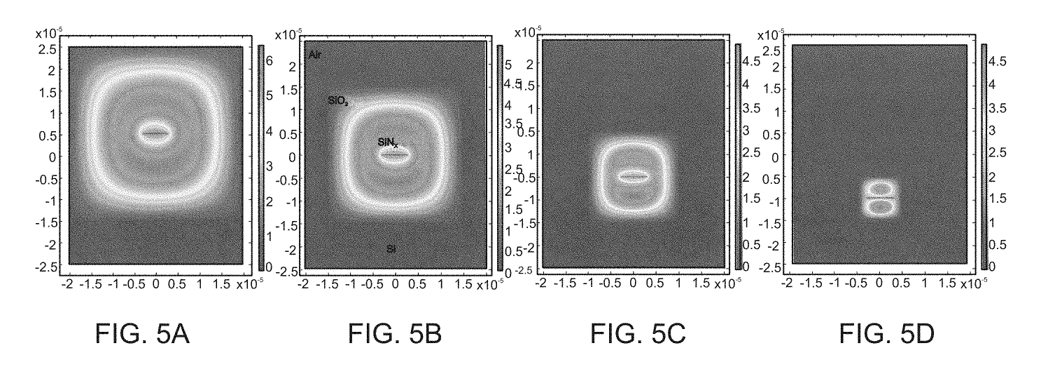

FIGS. 5A-5D are modeled graphical representations of the lowest-order acoustic modes for acoustic ridge waveguides, which are supported by different sized cladding regions of silicon dioxide on a silicon substrate, with the cladding regions surrounding a silicon nitride optical waveguide. FIG. 5A corresponds to the largest cladding region, and FIG. 5D corresponds to the smallest cladding region. FIGS. 5A-5D show that the acoustic mode area decreases as the silicon dioxide ridge dimensions decrease, leading to an increase in the Brillouin gain coefficient.

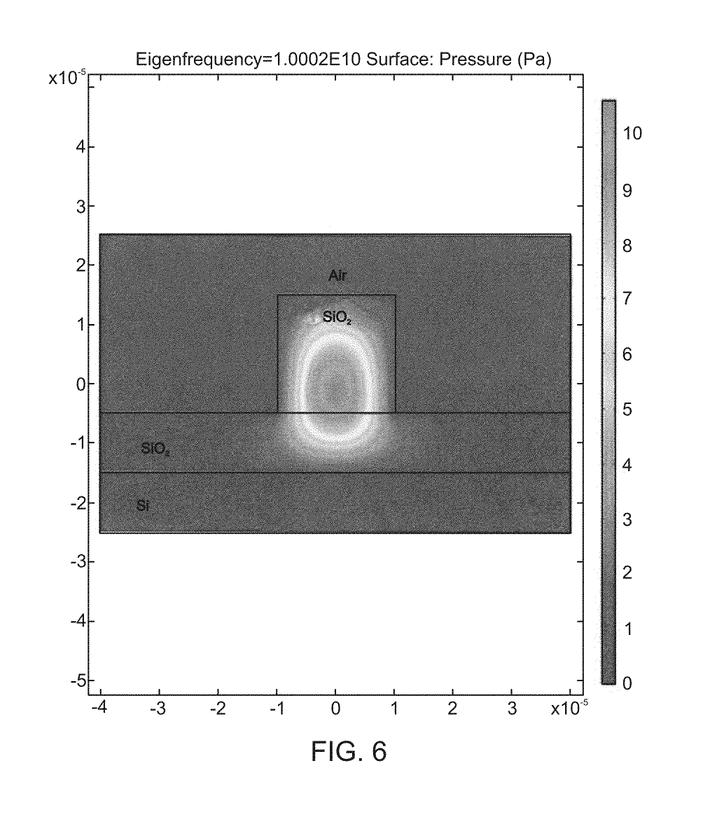

FIG. 6 is a modeled graphical representation of the lowest-order acoustic mode for an acoustic rib waveguide, which is supported by a cladding region of silicon dioxide surrounding an optical waveguide, and a rib layer of silicon dioxide on a silicon substrate. FIG. 6 shows that the silicon dioxide portion of the waveguide does not need to be fully etched in order to confine acoustic modes to the area around the optical waveguide, or to increase the Brillouin gain coefficient.

The acoustic rib or ridge waveguide devices disclosed herein may be used, for example, in an integrated photonics circuit, in either a straight waveguide or a resonator, to couple energy from a forward propagating pump wave into a counter-propagating Stokes wave. This process may be cascaded multiple times, corresponding to the generation of higher-order Stokes waves propagating in alternating directions. The Stokes waves may act as carriers for data encoded in the optical regime, may serve to monitor the Sagnac effect in optical gyroscopes, or may monitor the temperature and stress in the constituent integrated photonics circuit.

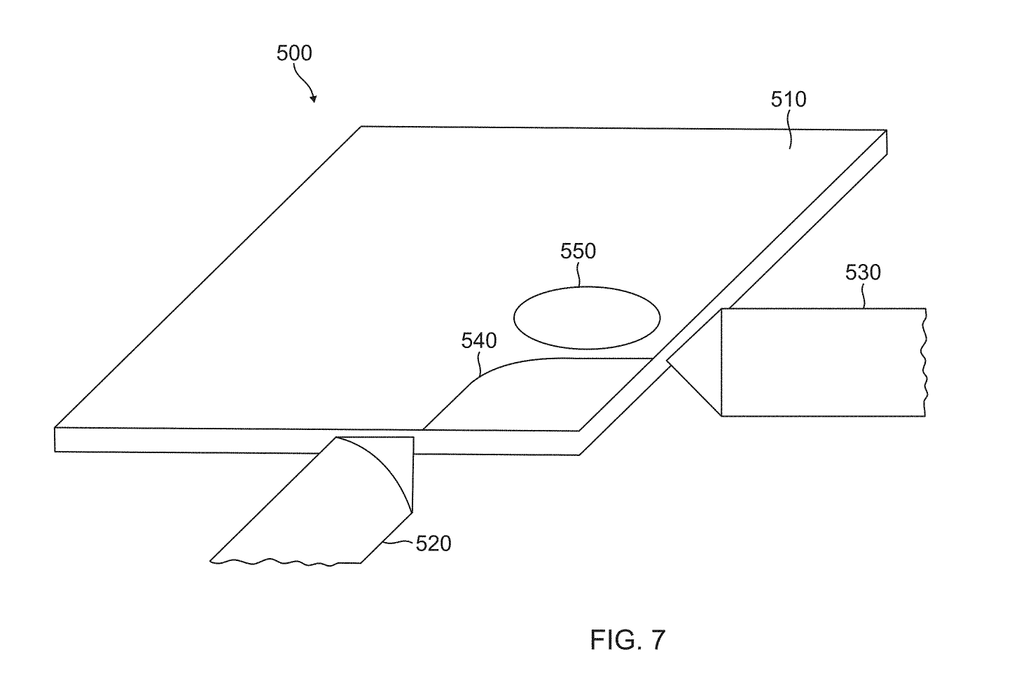

FIG. 7 illustrates an example of an integrated fiber optic gyroscope 500, which can employ the acoustic rib or ridge waveguide devices. The fiber optic gyroscope 500 includes an integrated photonics circuit or chip 510, which is in optical communication with an input optical fiber 520 and an output optical fiber 530. The input optical fiber 520 directs a light beam from a source to a waveguide 540, such as an acoustic rib or ridge waveguide, in chip 510. Counter-propagating light beams are generated in one or more ring resonators 550 coupled to waveguide 540 in chip 510. The beat frequencies of the counter-propagating light beams are used to determine the rate of rotation based on output optical signals received by output optical fiber 530.

### Example Embodiments

Example 1 includes a waveguide device comprising: a substrate having an upper surface and a first width; a cladding layer over the upper surface of the substrate, the cladding layer comprising a first material having a first refractive index, wherein the cladding layer has a second width that is less than the first width; and an optical core surrounded by the cladding layer, the optical core comprising a second material having a second refractive index that is higher that the first refractive index such that an optical signal will propagate through the optical core; wherein the cladding layer that surrounds the optical core has a thickness configured to substantially confine acoustic waves to the cladding layer when the optical signal propagates through the optical core.

Example 2 includes the waveguide device of Example 1, further comprising opposing rib sections on the upper surface of the substrate, the opposing rib sections located on opposite sides of the cladding layer.

Example 3 includes the waveguide device of Example 2, wherein the rib sections comprise the first material having the first refractive index.

Example 4 includes the waveguide device of Example 1, wherein the upper surface of the substrate is exposed on opposite sides of the cladding layer.

Example 5 includes the waveguide device of any of Examples 1-4, wherein the first material of the cladding layer comprises silicon dioxide, silicon oxynitride, zinc oxide, aluminum oxide, calcium fluoride, or combinations thereof.

Example 6 includes the waveguide device of any of Examples 1-5, wherein the second material of the optical core comprises silicon, silicon nitride, silicon oxynitride, silicon carbide, diamond, silicon germanium, germanium, gallium arsenide, gallium nitride, gallium phosphide, lithium niobate, or combinations thereof.

Example 7 includes the waveguide device of any of Examples 1-6, wherein the first material of the cladding layer has an acoustic velocity that is different than an acoustic velocity of the substrate.

Example 8 includes the waveguide device of any of Examples 1-7, wherein the waveguide device is implemented in an integrated photonics circuit or chip.

Example 9 includes the waveguide device of Example 8, wherein the integrated photonics circuit or chip is part of a fiber optic gyroscope.

Example 10 includes a method of fabricating a waveguide device, the method comprising: providing an integrated optical waveguide comprising a wafer substrate having an upper surface; a cladding layer supported by the wafer substrate, the cladding layer comprising a first material having a first refractive index; and an optical core surrounded by the cladding layer, the optical core comprising a second material having a second refractive index that is higher that the first refractive index. The method also comprises forming a mask on a portion of an upper surface of the cladding layer over the optical core; and removing a portion of the cladding layer unprotected by the mask such that the optical core is embedded in a remaining portion of the cladding layer; wherein the remaining portion of the cladding layer has a thickness that substantially confines acoustic waves to the remaining portion of the cladding layer when an optical signal propagates through the optical core.

Example 11 includes the method of Example 10, wherein the portion of the cladding layer is removed such that opposing rib sections of cladding material are formed on the upper surface of wafer substrate.

Example 12 includes the method of Example 10, wherein the portion of the cladding layer is removed such that the upper surface of the substrate is exposed on opposite sides of the cladding layer.

Example 13 includes the method of any of Examples 10-12, wherein the first material of the cladding layer comprises silicon dioxide, silicon oxynitride, zinc oxide, aluminum oxide, calcium fluoride, or combinations thereof.

Example 14 includes the method of any of Examples 10-13, wherein the second material of the optical core comprises silicon, silicon nitride, silicon oxynitride, silicon carbide, diamond, silicon germanium, germanium, gallium arsenide, gallium nitride, gallium phosphide, lithium niobate, or combinations thereof.

Example 15 includes the method of any of Examples 10-14, wherein the first material of the cladding layer has an acoustic velocity that is different than an acoustic velocity of the wafer substrate.

Example 16 includes the method of any of Examples 10-15, wherein the portion of the cladding layer is removed by a wet etch or a dry etch.

Example 17 includes the method of any of Examples 10-16, wherein the mask comprises a photoresist, an electron beam resist, or a metal.

Example 18 includes the method of any of Examples 10-17, further comprising removing the mask after the portion of the cladding layer is removed.

Example 19 includes the method of any of Examples 10-18, wherein the waveguide device is formed as part of an integrated photonics circuit or chip.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A waveguide device, comprising:
a substrate having an upper surface and a first width;
a cladding layer over the upper surface of the substrate, the cladding layer comprising a first material having a first refractive index, wherein the cladding layer has a second width that is less than the first width; and
an optical core surrounded by the cladding layer, the optical core comprising a second material having a second refractive index that is higher that the first refractive index such that an optical signal will propagate through the optical core;
wherein the cladding layer that surrounds the optical core has a thickness configured to substantially confine acoustic waves to the cladding layer when the optical signal propagates through the optical core.

2. The waveguide device of claim 1, further comprising opposing rib sections on the upper surface of the substrate, the opposing rib sections located on opposite sides of the cladding layer.

3. The waveguide device of claim 2, wherein the rib sections comprise the first material having the first refractive index.

4. The waveguide device of claim 1, wherein the upper surface of the substrate is exposed on opposite sides of the cladding layer.

5. The waveguide device of claim 1, wherein the first material of the cladding layer comprises silicon dioxide, silicon oxynitride, zinc oxide, aluminum oxide, calcium fluoride, or combinations thereof.

6. The waveguide device of claim 1, wherein the second material of the optical core comprises silicon, silicon nitride, silicon oxynitride, silicon carbide, diamond, silicon germanium, germanium, gallium arsenide, gallium nitride, gallium phosphide, lithium niobate, or combinations thereof.

7. The waveguide device of claim 1, wherein the first material of the cladding layer has an acoustic velocity that is different than an acoustic velocity of the substrate.

8. The waveguide device of claim 1, wherein the waveguide device is implemented in an integrated photonics circuit or chip.

9. The waveguide device of claim 8, wherein the integrated photonics circuit or chip is part of a fiber optic gyroscope.

10. A method of fabricating a waveguide device, the method comprising:
providing an integrated optical waveguide comprising:
a wafer substrate having an upper surface;
a cladding layer supported by the wafer substrate, the cladding layer comprising a first material having a first refractive index; and
an optical core surrounded by the cladding layer, the optical core comprising a second material having a second refractive index that is higher that the first refractive index;
forming a mask on a portion of an upper surface of the cladding layer over the optical core; and
removing a portion of the cladding layer unprotected by the mask such that the optical core is embedded in a remaining portion of the cladding layer;
wherein the remaining portion of the cladding layer has a thickness that substantially confines acoustic waves to the remaining portion of the cladding layer when an optical signal propagates through the optical core.

11. The method of claim 10, wherein the portion of the cladding layer is removed such that opposing rib sections of cladding material are formed on the upper surface of wafer substrate.

12. The method of claim 10, wherein the portion of the cladding layer is removed such that the upper surface of the substrate is exposed on opposite sides of the cladding layer.

13. The method of claim 10, wherein the first material of the cladding layer comprises silicon dioxide, silicon oxynitride, zinc oxide, aluminum oxide, calcium fluoride, or combinations thereof.

14. The method of claim 10, wherein the second material of the optical core comprises silicon, silicon nitride, silicon oxynitride, silicon carbide, diamond, silicon germanium, germanium, gallium arsenide, gallium nitride, gallium phosphide, lithium niobate, or combinations thereof.

15. The method of claim 10, wherein the first material of the cladding layer has an acoustic velocity that is different than an acoustic velocity of the wafer substrate.

16. The method of claim 10, wherein the portion of the cladding layer is removed by a wet etch or a dry etch.

17. The method of claim 10, wherein the mask comprises a photoresist, an electron beam resist, or a metal.

18. The method of claim 10, further comprising removing the mask after the portion of the cladding layer is removed.

19. The method of claim 10, wherein the waveguide device is formed as part of an integrated photonics circuit or chip.
